(19) United States
(12) Patent Application Publication
(10) Pub. No.: US 2017/0291773 A1
(43) Pub. Date: Oct. 12, 2017

(54) BELT CLEANER

(71) Applicant: MAFREN Co., Ltd., Kitakyushu-shi (JP)

(72) Inventor: Kazumi Daitoku, Kitakyushu-shi (JP)

(73) Assignee: MAFREN Co., Ltd., Kitakyushu-shi (JP)

(21) Appl. No.: 15/358,418

(22) Filed: Nov. 22, 2016

(30) Foreign Application Priority Data
Apr. 12, 2016 (JP) 2016-079326
May 26, 2016 (JP) 2016-104824

(51) Int. Cl. B65G 45/16

(52) U.S. Cl. CPC B65G 45/16

(57) ABSTRACT

In a belt cleaner 10 having a plurality of bar-like rubber elastic bodies 20 each having a rectangular cross section and provided in line in a groove 40a of a stand 40 installed in a width direction of a returning-side belt 30 one of springs 22 is provided to a fixed-side end 20a of each of the bar-like rubber elastic bodies 20 through a corresponding one of fixing axes 21, one of screws 62 is provided to each of flanges 44 provided to each end of the stand 40, one of thrust bolts 60 is rotatably attached to each of the screws 62, and the bar-like rubber elastic bodies 20 provided in line are retained in a horizontal direction in a state of being vertically pressed by the springs 22 at an adequate pressure by means of the thrust bolts 60 threaded into the screws 62.

### TECHNICAL FIELD

The present invention relates to a belt cleaner that scrapes off objects adhered to a surface of a returning-side belt of a belt conveyor for use in conveyance of raw materials, and that has scraping portions of which heights are made adjustable in accordance with a shape of a belt.

### BACKGROUND ART

In general, in a belt conveyor, by winding a rubber belt having a predetermined width endlessly in between a driving pulley and a driven pulley and rotating the driving pulley, the belt is made to perform circling motion in between the both pulleys. Objects to be conveyed are normally conveyed placed on a carrier belt (a conveying-side belt), and swept out on a driving pulley side, then the carrier belt turns into a return belt (a returning-side belt) and returns back to the driven pulley. However, there has been a problem in that objects to be conveyed adhered to a surface of the returning-side belt (objects adhered to the belt) drop down on the way back to the driven pulley, and accumulate under the returning-side belt. There has also been a problem in that the adhered objects wear return rollers and a snap pulley, or adhere to these rollers, making the returning-side belt meander.

In order to efficiently scrape off and collect objects adhered to a returning-side belt, a belt cleaner is usually provided at a very tip of the returning-side belt. With regard to belt cleaners, there are a scraper method that scrapes off adhered objects by means of a fixed scraping board by pressing the scraping board against a returning-side belt, a brushing method that brings a brush into contact with a returning-side belt, a cleansing method that sprays a high-pressure fluid, and the like. However, the scraper method is heavily used due to its simple structure and easy replacement.

Conveyor belts gradually wear in proportion as the use of the conveyor belts; however, they do not wear evenly but wear selectively and significantly in central portions. Thus, when the belts are old, the belts have a difference in thickness by a few millimeters between the central portions and end portions. In the case of long belts, the belts are sometimes not wholly replaced all at once in view of cost and work hour saving, and in some cases, an old belt significantly worn in a central portion and an unworn new belt are mixed. With respect to a belt that is unevenly worn, a height of a belt cleaner is adjusted to a most worn part. However, pressing force becomes uneven in a width direction of the belt. An endless portion (connecting portion) of the belt falls away over time and ends of the endless portion start to peel. Since these peeled portions protrude from a surface of a returning-side belt, when the belt cleaner exceeds deflection limit of the belt cleaner, there is a risk that the peeled portions will damage the belt cleaner. Additionally, when the pressing force of the belt cleaner is large, it encourages the peeling of the endless portion and the like, becoming a factor of belt damage. Therefore, belt cleaners are essential for scraping off objects adhered to surfaces of belts, however, when the belt cleaners are not appropriately attached or used, the belt cleaners could damage the belts and cause production impediments. There have been proposals of belt cleaners in various shapes and with various functions to this day, however, a belt cleaner free of maintenance and excellent in scraping efficiency has not been realized yet.

Requirements necessary for the scraper method belt cleaners are as follows: (1) scraping portions (chips) of a belt cleaner are made capable of precisely coming into direct contact with concavities and convexities in a width direction of a returning-side belt when attaching the belt cleaner to a surface of the returning-side belt; (2) scraping performance is made capable of being recovered automatically by elevation of the chips in accordance with degradation of the scraping performance due to the wearing of the chips; (3) with respect to objects firmly adhered to the returning-side belt and peeling of the endless portion (connecting portion), the chips are made capable of largely bending in a traveling direction of the returning-side belt and instantly letting obstacles pass so as to avoid the damage of the belt cleaner, and instantly going back to the normal scraping condition; (4) the chips are made capable of infallibly scraping off adhered objects over a long period of time; (5) the chips have long service lives and can be easily replaced; (6) the belt cleaner has long regulatory cycle and replacement cycle, and the belt cleaner can be easily regulated and attached/replaced; and (7) objects do not adhere to a body of the belt cleaner, or an amount of adhered objects is extremely small. A large variety of belt cleaners have been proposed in the past in an attempt to satisfy the above features. However, a satisfactory method has not been realized yet.

Patent Literature 1 has shown a method for scraping off adhered objects by pressing a rectangular scraping board against a returning-side belt. In the case of this method, the rectangular scraping board could not come into direct contact with the returning-side belt having transformed into a concave arc-like shape, leaving some objects un-scraped. When scraping performance of the scraping board degraded due to wearing of the scraping board, it was necessary to stop a conveyor and adjust a state of direct contact between the scraping board and the returning-side belt. Additionally, since the scraping board has high stiffness and cannot be largely and flexibly bent, there was a problem in that the belt and the scraping board would become damaged when peelings in the endless portion and protruding objects adhered to the belt collided with the scraping board.

Patent Literature 2 has disclosed a cleaner having chips attached to tips of bar-like rubber elastic bodies in order to solve the problematic points of the scraper method cleaners. In the case of this method, though protrusions such as objects firmly adhered to a returning-side belt and peelings in an endless portion can be instantly avoided, it was difficult to adjust heights of the chips so as to follow a concave arc-like shape on an upper side of the returning-side belt when attaching an actual equipment.

Patent Literature 3 has shown a belt cleaner in which a plurality of scrapers provided in line in a width direction of a belt are supported by a plate spring, and a height of each of the scrapers is adjusted by making the plate spring elastically bent by means of set bolts. In the case of this method, when the plate spring moved upward in an arc-like state, the scrapers open up in a fan-like form, which made a gap at a tip of each of the scrapers, linearly leaving some objects un-scraped. When the scrapers had high stiffness, the scrapers could not instantly bend and avoid protruding objects on the returning-side belt, which made the belt and the belt cleaner damaged. Since there was a small number of bolts, scraping portions could not be precisely brought into direct contact with a surface of the returning-side belt, and scraping performance degraded.

Patent Literature 4 has shown a belt cleaner in which scraping blocks are connected with each other by a wire so that the scraping blocks would not be separated from each other, and the scraping blocks are supported by positioning members such as bolts. In the case of this method, there was a problem in that, when the wire was loose, the scraping blocks separated from each other, or a tip of each of the scraping blocks spread open in a fan-like form, lineally leaving some objects un-scraped. When the scraping blocks were sintered bodies of metal oxide, due to high stiffness of the scraping blocks, the scraping blocks could not instantly bend and avoid protruding objects on the returning-side belt, which damaged the belt and belt cleaner. Additionally, in order to adjust the bolts, it was necessary for humans to enter or climb under a lower portion of the returning-side belt and work, which has been a problem in a safety aspect and an environmental aspect. Also, it required a great amount of time to adjust a large number of bolts and bring the scraping portions into direct contact with the returning-side belt, necessitating long downtime of a conveyor.

Further, Patent Literature 2 has shown a method for fixing sticks by providing sticks in line in a groove of a stand formed from a pressing-side plate and a receiving-side plate, and pushing in the pressing plate by means of a plurality of bolts provided to the pressing-side plate. In the case of this method, since heights of the sticks could not be adjusted, the sticks and a returning-side belt could not be accurately brought into direct contact with one another, leaving some objects un-scraped.

### CITATION LIST

### Patent Literature

Patent Literature 1: Japanese Unexamined Patent Application Publication No. H11-292250

### Patent Literature 2: Japanese Unexamined Patent Application Publication No. 2013-252976

Patent Literature 3: Japanese Unexamined Utility Model Application Publication No. S52-144590

### Patent Literature 4: Japanese Unexamined Patent Application Publication No. 2013-023353

### SUMMARY OF INVENTION

### Technical Problem

The present invention solves the following problems: (1) making it possible to perform height adjustment for scraping portions of a belt cleaner without humans climbing under a lower portion of a returning-side belt; (2) making it possible to automatically adjust heights of bar-like rubber elastic bodies each rectangular in cross section, i.e., the scraping portions of the belt cleaner, in conformity to a shape of the returning-side belt when attaching an actual equipment; (3) making it possible to adjust the heights of each of the bar-like rubber elastic bodies individually; (4) making it possible for chips to automatically move upward in conformity to wear on the scraping portions (chips) so that the chips and a surface of the returning-side belt can constantly and appropriately be in direct contact with one another; and (5) making it possible for the bar-like rubber elastic bodies to accurately return to normal scraping positions when largely bent by protruding objects on the returning-side belt.

### Solution to Problem

A belt cleaner according to the present invention comprises a plurality of bar-like rubber elastic bodies each having a rectangular (including square, the same shall apply hereafter) cross section and provided in line in a groove of a stand installed in a width direction of a returning-side belt, wherein one of fixing axes attached to a fixed-side end of each of the bar-like rubber elastic bodies in a central axial direction of each of the bar-like rubber elastic bodies, each of the fixing axes is inserted in a corresponding one of retention guide holes provided in a bottom plate of the stand and is vertically retaining a corresponding one of the bar-like rubber elastic bodies, each of springs is inserted in a corresponding one of the fixing axes, and each of the springs is held in between the fixed-side end of a corresponding one of the bar-like rubber elastic bodies and the bottom plate,

one of flanges is provided to each end of the stand, one of through-holes is provided to each of the flanges in the width direction of the returning-side belt, one of screws is provided to each of the through-holes, and one of thrust bolts is rotatably attached to each of the screws, and
after pushing the stand upward until an unfixed-side end of each of the bar-like rubber elastic bodies come into direct contact with a surface of the returning-side belt and pressing the bar-like rubber elastic bodies further against the returning-side belt until the springs each exhibit a target compression amount, the thrust bolts are pressed against the bar-like rubber elastic bodies to fix movement of the bar-like rubber elastic bodies in a thrust direction (horizontal direction) and in a vertical direction.

In the case of the belt cleaner according to the present invention, each of the flanges can be attached with one of supporting pipes for supporting the stand, and each of the thrust bolts is housed in a corresponding one of the supporting pipes.

### Advantageous Effects of Invention

The belt cleaner according to the present invention has the following effects. (1) By pressing the bar-like rubber elastic bodies each having a rectangular cross section against the returning-side belt, the springs become compressed, and the bar-like rubber elastic bodies can be pressed to the returning-side belt at an appropriate load. By screwing the thrust bolts in this state and pressing the bar-like rubber elastic bodies, the bar-like rubber elastic bodies adjacent to one another are pressed in the thrust direction (width direction of the returning-side belt), which makes the bar-like rubber elastic bodies constrained in the vertical direction and in the thrust direction, allowing for positioning. (2) Since the thrust bolts can be operated from outside the belt conveyor, operations can be safely performed. (3) Since the fixing axes are attached to the fixed-side ends of the bar-like rubber elastic bodies and the fixing axes are inserted in the retention guide holes in the bottom plate, the bar-like rubber elastic bodies can be vertically and firmly attached to the stand. (4) Since each of the bar-like rubber elastic bodies is integral with a corresponding one of the fixing axes, the bar-like rubber elastic bodies and the stand can be accurately and easily assembled by just inserting the fixing axes in the retention guide holes in the bottom plate. (5) Since moment impinges on friction force (horizontal force) in the traveling direction of the returning-side belt in between the retention guide holes and the fixing axes, the bar-like rubber elastic bodies do not fall out.

In the case of the belt cleaner according to the present invention, when the thrust bolts are housed inside the supporting pipes, chances of adhesion of dust and corrosion are decreased, and the thrust bolts can be maintained in good condition over a long period of time. Additionally, the belt cleaner can be compactly structured.

### BRIEF DESCRIPTION OF DRAWINGS

FIG. 1 is a perspective view of a belt cleaner according to one embodiment of the present invention.

FIG. 2 is a partial perspective view of the same belt cleaner.

FIG. 3 is a partial front cross-sectional view of a state in which springs are attached to fixing axes of the same belt cleaner.

FIGS. 4(a) to 4(d) each are cross-sectional views of examples of attachment of fixing axes to bar-like rubber elastic bodies.

FIG. 5 is a cross-sectional view of a state in which the springs are inserted in the fixing axes of the same belt cleaner.

FIG. 6 is a longitudinal cross-sectional view of a state in which the springs are inserted in the fixing axes of the same belt cleaner.

FIG. 7 is a front cross-sectional view of the same belt cleaner provided with thrust bolts.

FIG. 8 is a lateral cross-sectional view of the same belt cleaner having chips that is provided with thrust bolts and fall prevention plates and that has spacers inserted between the bar-like rubber elastic bodies adjacent to one another.

FIG. 9 is a lateral cross-sectional view of the same belt cleaner having chips.

FIG. 10 is a partially-enlarged cross-sectional view of the same belt cleaner having chips that is provided with the thrust bolts and the fall prevention plates and that has spacers inserted between the bar-like rubber elastic bodies adjacent to one another.

### DESCRIPTION OF EMBODIMENTS

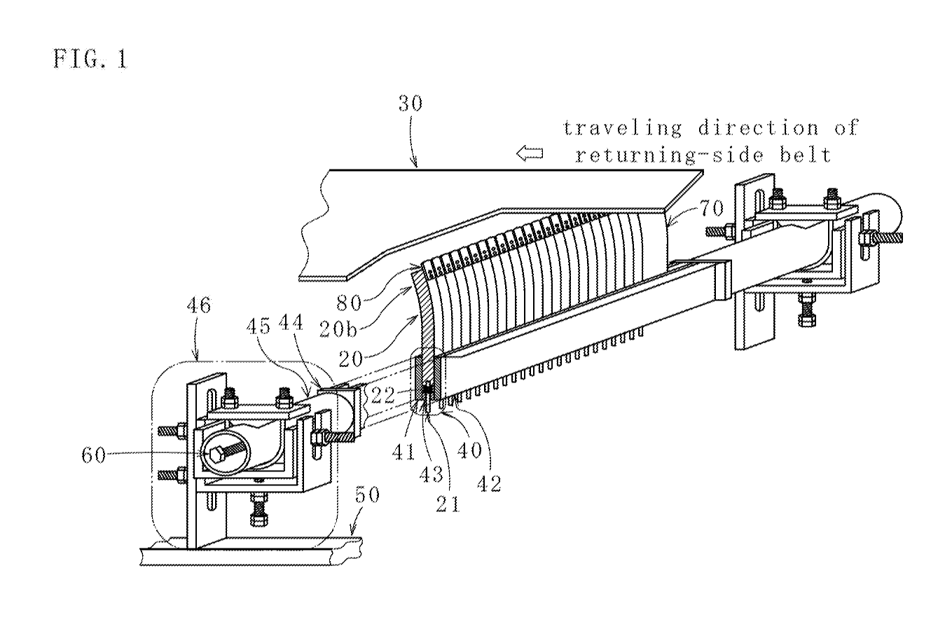

Descriptions will be given on a belt cleaner 10 according to one embodiment of the present invention on the basis of FIGS. 1 to 10.

The belt cleaner 10 has a plurality of bar-like rubber elastic bodies 20 each having a rectangular cross section and provided in line in a groove 40a of a stand 40 arranged in a width direction of a returning-side belt 30. One of fixing axes 21 is attached to fixed-side terminal (fixed-side end) 20a of each of the bar-like rubber elastic bodies 20 in central axis 20c direction of each of the bar-like rubber elastic bodies 20. Each of the fixing axes 21 is inserted in a corresponding one of retention guide holes 43a provided in a bottom plate 43 of the stand 40, vertically retaining a corresponding one of the bar-like rubber elastic bodies 20. Each of springs 22 is inserted in a corresponding one of the fixing axes 21, and each of the springs 22 is held in between the fixed-side end 20a of a corresponding one of the bar-like rubber elastic bodies 20 and the bottom plate 43.

One of flanges 44 is provided to each end of the stand 40, one of through-holes 44a is provided to each of the flanges 44 in the width direction of the returning-side belt 30, one of screws (nuts) 62 is provided to each of the through-holes 44a, and one of thrust bolts 60 is rotatably attached to each of the screws 62.
When using the belt cleaner 10, after pushing the bar-like rubber elastic bodies 20 upward through the stand 40 to make the bar-like rubber elastic bodies 20 come into direct contact with the returning-side belt 30, and pressing the bar-like rubber elastic bodies 20 against the returning-side belt 30 until the springs 22 each exhibit a target compression amount, the thrust bolts 60 are pressed against the bar-like rubber elastic bodies 20 to fix movement of the bar-like rubber elastic bodies 20 in a thrust direction and a vertical direction. More detailed descriptions will be given hereunder on the belt cleaner 10.

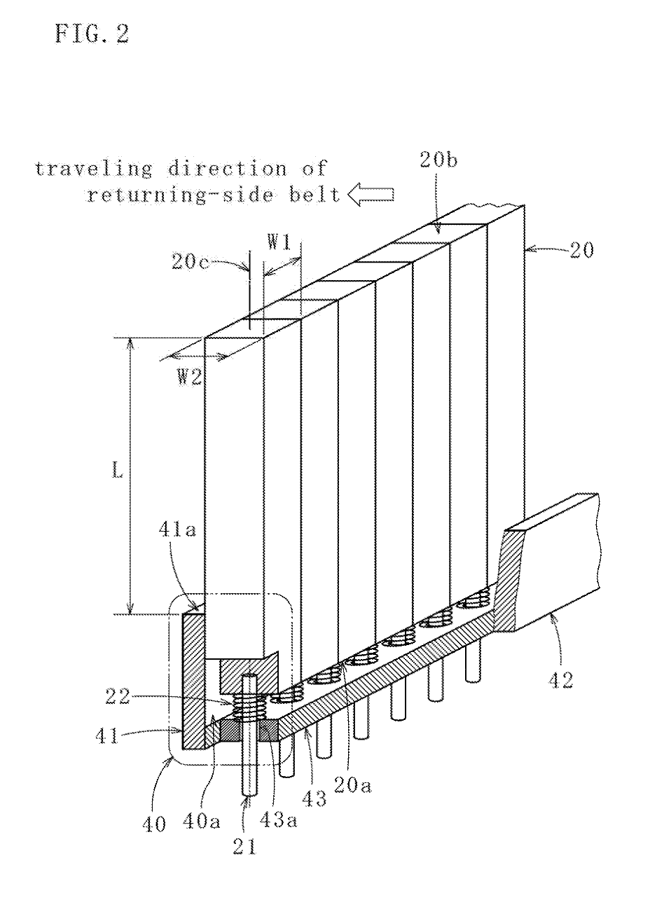

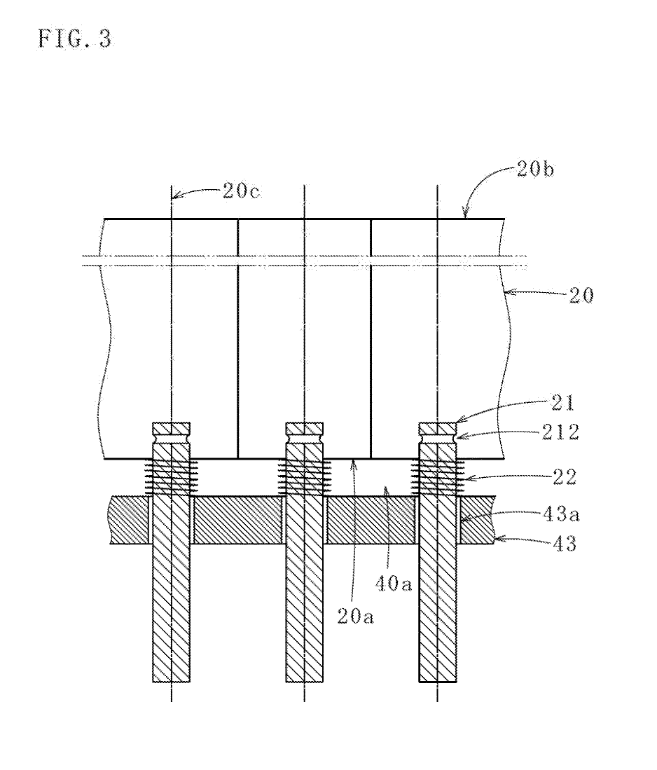

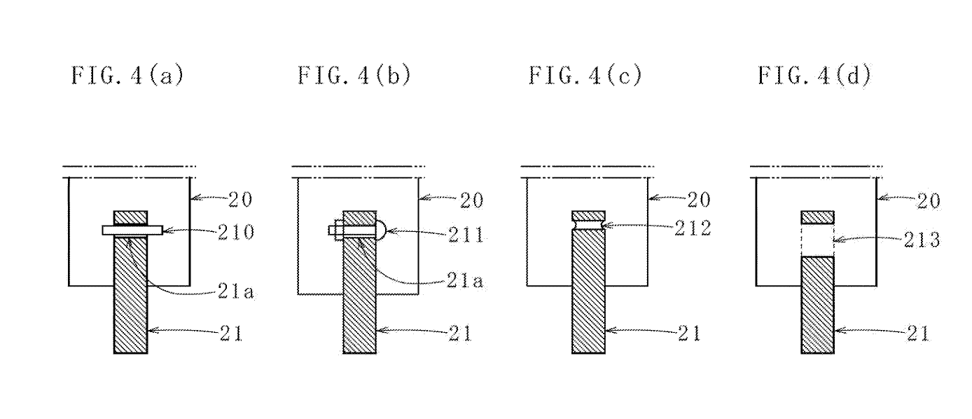

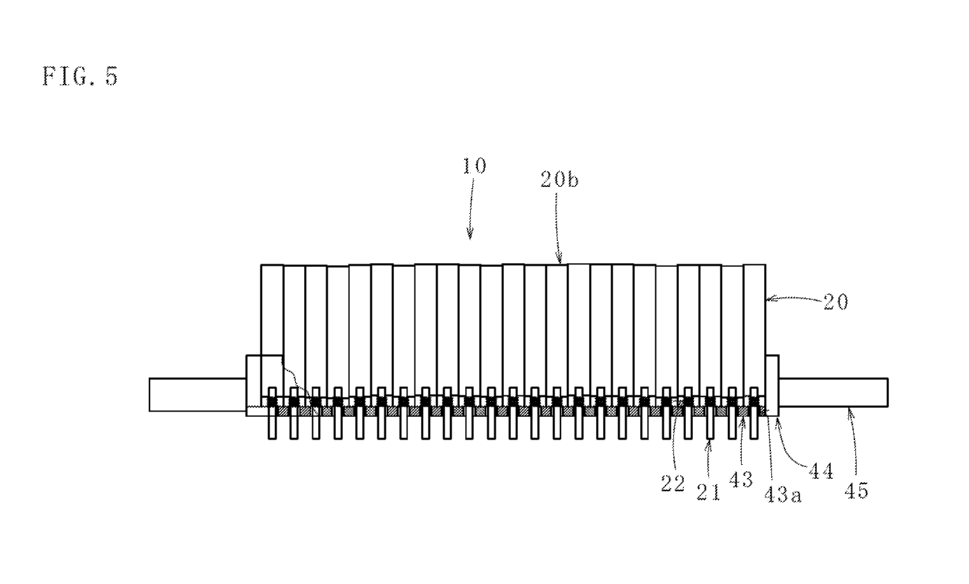

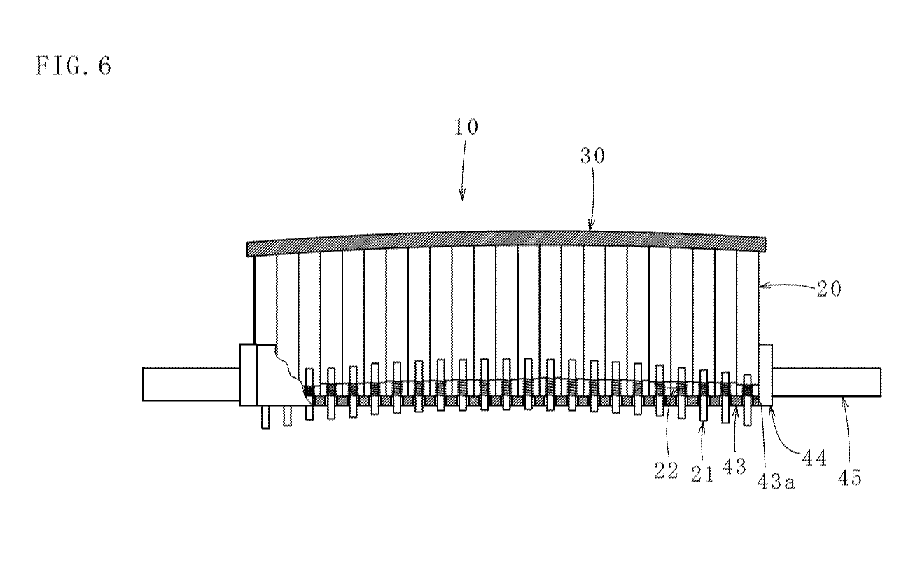

FIG. 1 is an overall perspective view of the partially cross-sectioned belt cleaner 10. FIG. 2 is a partial cross-sectional view of a state in which each of the springs 22 is placed between a corresponding one of the bar-like rubber elastic bodies 20 and the bottom plate 43, and each of the fixing axes 21 is inserted in a corresponding one of the springs 22 and a corresponding one of the retention guide holes 43a. FIG. 3 is a partially-enlarged cross-sectional view of the state in which each of the springs 22 is placed between the corresponding one of the bar-like rubber elastic bodies 20 and the bottom plate 43, and each of the fixing axes 21 is inserted in the corresponding one of the springs 22 and the corresponding one of the retention guide holes 43a. FIGS. 4(a) to 4(d) each are cross-sectional views illustrating examples of a method of attaching the fixing axes 21 to the bar-like rubber elastic bodies 20. FIG. 5 is a front elevation of the whole belt cleaner 10 laterally cross-sectioned, the belt cleaner 10 having the bar-like rubber elastic bodies 20 provided in line and each attached with the corresponding one of the fixing axes 21 and the springs 22. FIG. 6 is a longitudinal cross-sectional view of a front elevation in a case where the belt cleaner 10 having the bar-like rubber elastic bodies 20 provided in line and each attached with the corresponding one of the fixing axes 21 and springs 22 is brought into direct contact with the returning-side belt 30.

Descriptions will be given on a structure of the belt cleaner 10 on the basis of FIGS. 1 to 6. The plurality of the bar-like rubber elastic bodies 20 are provided in line and fixed in the groove 40a in the stand 40. The bar-like rubber elastic bodies 20 are inserted in the groove 40a provided in the groove-shaped stand 40. The groove 40a is formed from a pressing-side plate 41, receiving-side plate 42, and the bottom plate 43. One of the fixing axes 21 is provided to the fixed-side end 20a of each of the bar-like rubber elastic bodies 20 in a direction of the central axis 20c of each of the bar-like rubber elastic bodies 20. Each of the fixing axes 21 is inserted in a corresponding one of the retention guide holes 43a provided in the bottom plate 43. Each of the springs 22 in which one of the fixing axes 21 is inserted is placed between the corresponding one of the bar-like rubber elastic bodies 20 and the bottom plate 43. One of the flanges 44 is attached to each side of the stand 40, and one of supporting pipes 45 is attached to both the flanges 44. Each of the supporting pipes 45 is fixed by one of belt cleaner attachment base portions 46 each fixed to one of conveyor stands 50.

Descriptions will be given on a procedure of setting the belt cleaner 10 to the returning-side belt 30 on the basis of FIGS. 1 to 6. As a first step, the stand 40 is pushed upward until the unfixed-side terminals (unfixed-side ends) 20b of the bar-like rubber elastic bodies 20 come into direct contact with the surface of the returning-side belt 30. As a second step, the bar-like rubber elastic bodies 20 are pressed further against the returning-side belt 30 until the springs 22 each are compressed to a target compression level. Due to the compression of the springs 22, with respect to concavities and convexities in the width direction of the returning-side belt 30, the bar-like rubber elastic bodies 20 can be brought into direct contact with the returning-side belt 30 with an appropriate amount of pressing force. As described above, operations in the first and the second steps are those that made it possible to perform the height adjustment operation for the belt cleaner 10 having a large number of scraping portions without the need for humans to climb under the lower portion of the returning-side belt 30, which significantly improved the operation of attaching the belt cleaner 10 in the safety aspect and the environmental aspect.

As the bar-like rubber elastic bodies 20 wear, the bar-like rubber elastic bodies 20 are pushed upward by the springs 22 in conformity to an amount of wear, and the bar-like rubber elastic bodies 20 can constantly maintain appropriate pressing force with respect to the returning-side belt 30. Thus, good scraping performance of the bar-like rubber elastic bodies 20 is automatically maintained over a long period of time. Due to this, the regulatory cycle and replacement cycle of the belt cleaner 10 can be delayed by a large margin, thereby realizing productivity enhancement and improvement in maintenance efficiency.

By pressing the bar-like rubber elastic bodies 20 against the returning-side belt 30 by means of elastic force of the springs 22, due to frictional force in the traveling direction of the returning-side belt 30, the bar-like rubber elastic bodies 20 fall (i.e., bend) in the traveling direction of the returning-side belt 30. By the falling of the bar-like rubber elastic bodies 20, pressing force having an appropriate amount of elasticity is applied to the returning-side belt 30, and adhered objects can be scraped off by instantly following up-and-down fluctuation resulting from the concavities and convexities or vibration of the returning-side belt 30.

It is required that the bar-like rubber elastic bodies 20 have pressing force for pressing the unfixed-side terminals 20b against the returning-side belt 30, and that the bar-like rubber elastic bodies 20 flexibly follow the subtle concavities and convexities of the returning-side belt 30. For these reasons, a rubber material such as, for example, natural rubber, synthetic rubber, styrene, butadiene rubber, chloroprene rubber, acrylic rubber, nitrile rubber, urethane rubber, fluororubber and the like can be used for the bar-like rubber elastic bodies 20.

For the fixing axes 21 attached to the bar-like rubber elastic bodies 20, metal sticks of carbon steel, SUS, titanium, copper and the like and resin such as plastic can be used. It is desirable for a diameter of each of the fixing axes 21 to be 3 to 10 mm. When the diameter is smaller than 3 mm, there is a risk that the fixing axes 21 will be bent by the thrust force and horizontal force due to the frictional force of the returning-side belt 30. When the diameter is larger than 10 mm, a diameter of each of the retention guide holes 43a in the bottom plate 43 of the stand 40 becomes large, causing a problem of decrease in stiffness of the bottom plate 43.

As a method for attaching the fixing axes 21 to the bar-like rubber elastic bodies 20, as illustrated in FIG. 2, it is possible to preliminarily make a hole in each of the bar-like rubber elastic bodies 20, then insert the fixing axes 21, and join the bar-like rubber elastic bodies 20 and the fixing axes 21 by means of an adhesive agent. When shaping the bar-like rubber elastic bodies 20 by means of a metallic mold, by preliminarily setting the fixing axes 21 in the metallic mold, the bar-like rubber elastic bodies 20 and the fixing axes 21 can be integrally shaped. In the case of integrally shaping the bar-like rubber elastic bodies 20 and the fixing axes 21 by means of a metallic mold, there are methods such as one in which through-holes 21a are provided to the fixing axes 21 and pins 210 become fixed as illustrated in FIG. 4(a), one in which bolts 211 are fixed to the through-holes 21a as illustrated in FIG. 4(b), one in which concavo-convex portions 212 are provided to the fixing axes 21 and rubber materials are curved inwardly as illustrated in FIG. 4(c), and one in which anchor holes 213 each having a large cross-section area are provided to the fixing axes 21, and anchors are made by filling a rubber material in the anchor holes 213 as illustrated in FIG. 4(d), all of which can prevent the fixing axes 21 from falling out.

It is desirable for an inside diameter of each of the springs to be 4 to 12 mm. When the inside diameter is smaller than 4 mm, the springs 22 come into contact with the fixing axes 21, which impedes expansion/contraction. When the inside diameter is larger than 12 mm, the springs 22 interfere with the adjacent springs 22, which also impedes the expansion/contraction. It is desirable for an expansion/contraction amount of each of the springs 22 to be 5 to 30 mm. In the case of 5 mm or less, the expansion/contraction amount is smaller than the amount of concavities/convexities on the surface of the returning-side belt 30, and the bar-like rubber elastic bodies 20 cannot precisely come into direct contact with the surface of the returning-side belt 30. In the case where the inside diameter is larger than 30 mm, there arises a problem in that the bar-like rubber elastic bodies 20 fall out due to the frictional force in the traveling direction of the returning-side belt 30. Stainless and spring steel are suitable as a material for the springs 22.

As illustrated in FIGS. 4, 5, and 6, by inserting the springs 22 in the fixing axes 21 attached to the bar-like rubber elastic bodies 20 and inserting the fixing axes 21 in the retention guide holes 43a in the bottom plate 43, the bar-like rubber elastic bodies 20 can be easily and precisely provided in line in the stand 40 without the height adjustment for the bar-like rubber elastic bodies 20 and centering adjustment for the bar-like rubber elastic bodies 20 in a longitudinal direction of the stand 40. As illustrated in FIG. 3, by accurate boring of the retention guide holes 43a in the bottom plate 43 of the stand 40, the bar-like rubber elastic bodies 20 can be provided in line in the groove 40a of the stand 40 with high precision. It is desirable for each of clearances between the retention guide holes 43a and the fixing axes 21 to be 0.1 to 1.0 mm. When the clearances are smaller than 0.1 mm, failures occur in the expansion/contraction of the springs 22 due to the friction between the retention guide holes 43a and the fixing axes 21. When the clearances are larger than 1.0 mm, the retention guide holes 43a cannot vertically retain the fixing axes 21. Keeping the clearances small allows for the substantially vertical retention of the bar-like rubber elastic bodies 20, and prevents the bar-like rubber elastic bodies 20 from being misaligned and falling in the thrust direction.

As illustrated in FIG. 2, the lateral cross sections of the bar-like rubber elastic bodies 20 are rectangular (including square). It is desirable for a width W1 of each of the bar-like rubber elastic bodies 20 in the width direction of the returning-side belt 30 and a width W2 of each of the bar-like rubber elastic bodies 20 in the traveling direction of the returning-side belt 30 to be 10 to 30 mm. When the width W1 is 10 mm or less, the stiffness decreases, and the scraping performance is lowered. When the width W1 is larger than 30 mm, the stiffness increases, and bending of the bar-like rubber elastic bodies 20 in the traveling direction of the returning-side belt 30 becomes small, which make the bar-like rubber elastic bodies 20 not flexibly follow the small concavities and convexities, and also make the bar-like rubber elastic bodies 20 incapable of precisely coming into direct contact with the small concavities and convexities in the width direction of the returning-side belt 30, lowering the scraping performance. Thus, in the case of increasing the stiffness of the bar-like rubber elastic bodies 20 with respect to the traveling direction of the returning-side belt 30, it is desirable to make the width W2 larger than the width W1. It is desirable for a length L of each of the bar-like rubber elastic bodies 20 to be 50 to 300 mm. As illustrated in FIG. 2, the length L refers to a length from an upper surface 41a of the pressing-side plate 41 to the unfixed-side terminals 20b of the bar-like rubber elastic bodies 20. When the length L is shorter than 50 mm, bending is too little, which lowers the ability to follow the returning-side belt 30. When the length L is longer than 300 mm, bending is too large, and the scraping force becomes lowered.

Mainstream conventional belt cleaners are scraping boards in which chips are attached to rubber elastic plates or metallic plates of about 100 to 500 mm in width. Since widths of the scraping boards are too large, it is impossible for the whole chips to come into even and direct contact with the surface of the returning-side belt 30, leaving some objects un-scraped. Since forcing a scraping board to come into contact with the returning-side belt 30 in order to resolve un-scraped objects makes the pressing force large, making the returning-side belt 30 wear, encouraging the peeling (protruding objects) in the endless portion, and the like, and the belt would become damage. In order to solve this problem, it is essential to make the unfixed-side terminals 20b of the bar-like rubber elastic bodies 20 evenly press the surface of the returning-side belt 30, instantly avoid protruding objects on the belt 30, and instantly return to the normal positions after avoiding the protruding objects by making the width W1 of each of the bar-like rubber elastic bodies 20 as small as possible.

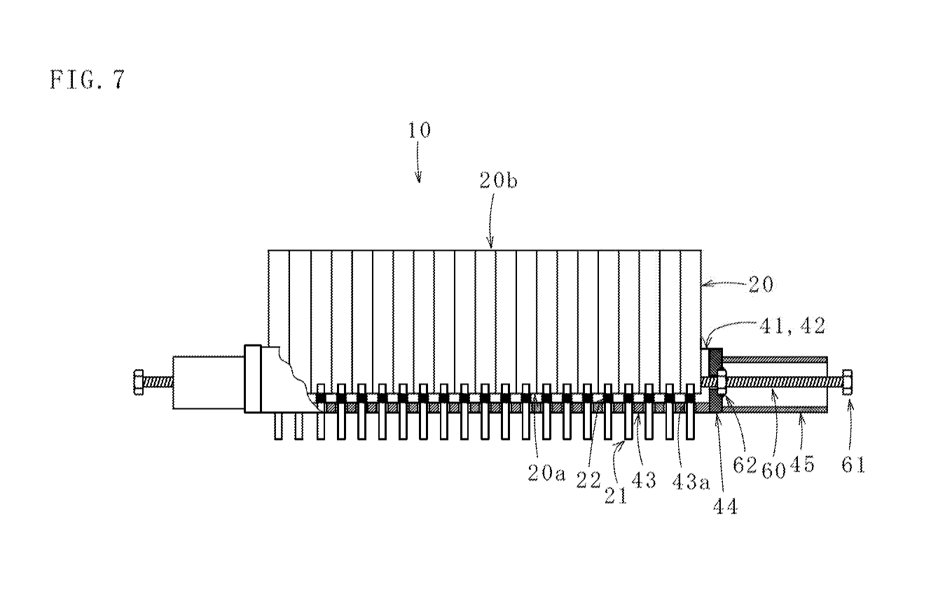

FIG. 7 is a front elevation of the cross-sectioned belt cleaner 10 in which the flanges 44 each having one of the through-holes 44a are provided to each side of the stand 40, and one of the thrust bolts 60 is attached to each of the screws (nuts) 62 provided to the flanges 44. The screws 62 may be formed in the through-holes 44a; however, as illustrated in FIGS. 7, 8, and 10, the screws 62 may also be formed by welding the nuts. The flanges 44 are welded and fixed so as to integrate the pressing-side plate 41, the receiving-side plate 42, and the bottom plate 43.

As illustrated in FIG. 7, by pressing the bar-like rubber elastic bodies 20 against the returning-side belt 30 and bending (compressing) the springs 22, the bar-like rubber elastic bodies 20 can be precisely brought into direct contact with the returning-side belt 30 with appropriate pressing force. However, in order to maintain this state, it is necessary to suppress the movement of the bar-like rubber elastic bodies 20 in the vertical direction and in the horizontal direction. Thus, the bar-like rubber elastic bodies 20 are squeezed from the both sides of the stand 40 by rotating tightening nuts 61 of the thrust bolts 60 and pressing the thrust bolts 60 against sides of the bar-like rubber elastic bodies 20. Since each of the bar-like rubber elastic bodies 20 is close to adjacent one(s) of the bar-like rubber elastic bodies 20, the pressing force from the thrust bolts 60 is transmitted to all of the bar-like rubber elastic bodies 20, and by each of the bar-like rubber elastic bodies 20 pushing one another, the movement of the bar-like rubber elastic bodies 20 in the vertical direction and in the horizontal direction can be suppressed.

That is, as the first step, the stand 40 is pushed upward until the unfixed-side terminals 20b of the bar-like rubber elastic bodies 20 come into direct contact with the surface of the returning-side belt 30. As the second step, the bar-like rubber elastic bodies 20 are pressed further against the returning-side belt 30 until the springs 22 each are compressed to a target deflection amount (compression amount). Then, as a third step, the bar-like rubber elastic bodies 20 are squeezed from the both sides of the stand 40 by the thrust bolts 60. Consequently, the bar-like rubber elastic bodies 20 can be firmly fixed. In the case of this method, there is no need for delicate positioning work to individually make each of the bar-like rubber elastic bodies 20 come into direct contact with the returning-side belt 30, and there is no need to individually fix each of the bar-like rubber elastic bodies 20 after the positioning.

A corresponding one of the supporting pipes 45 for supporting the stand 40 is attached to each of the flanges 44, and each of the thrust bolts 60 is housed in a corresponding one of the supporting pipes 45.

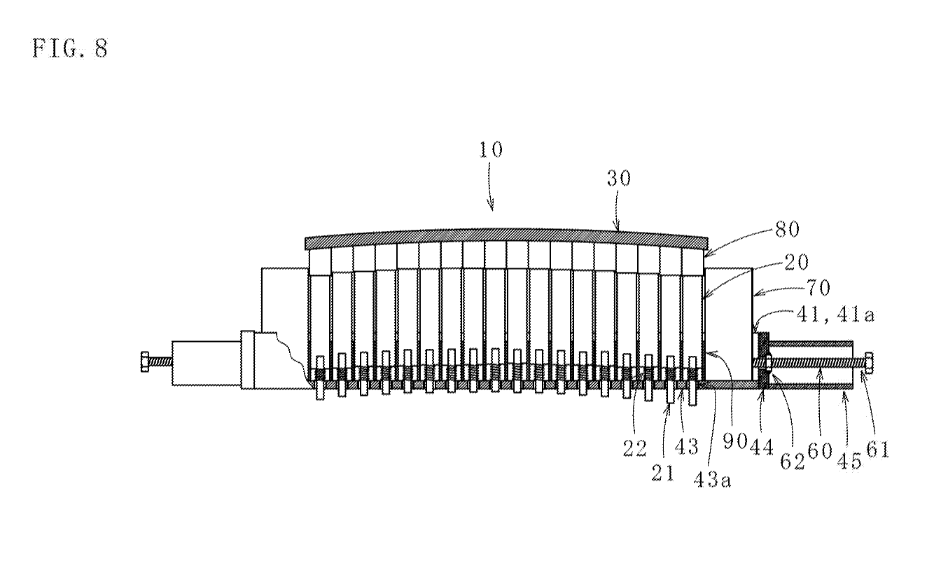

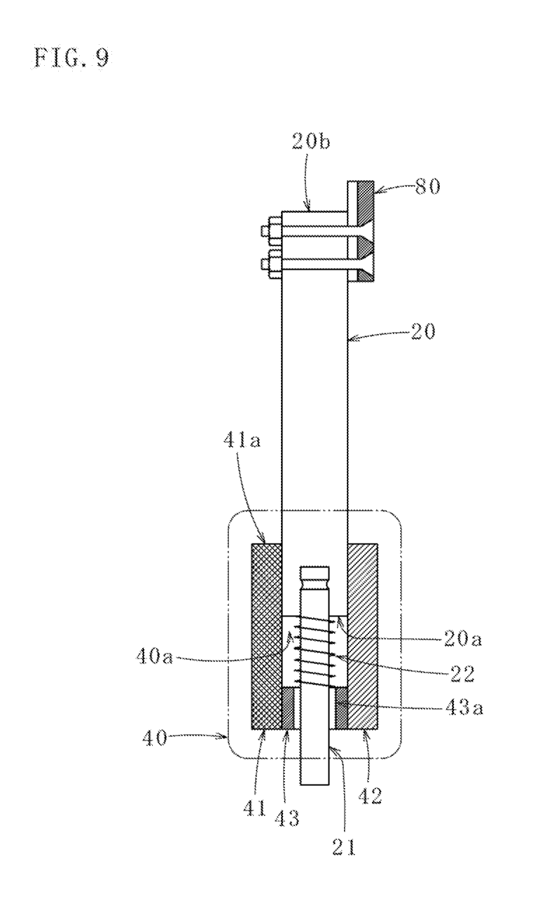

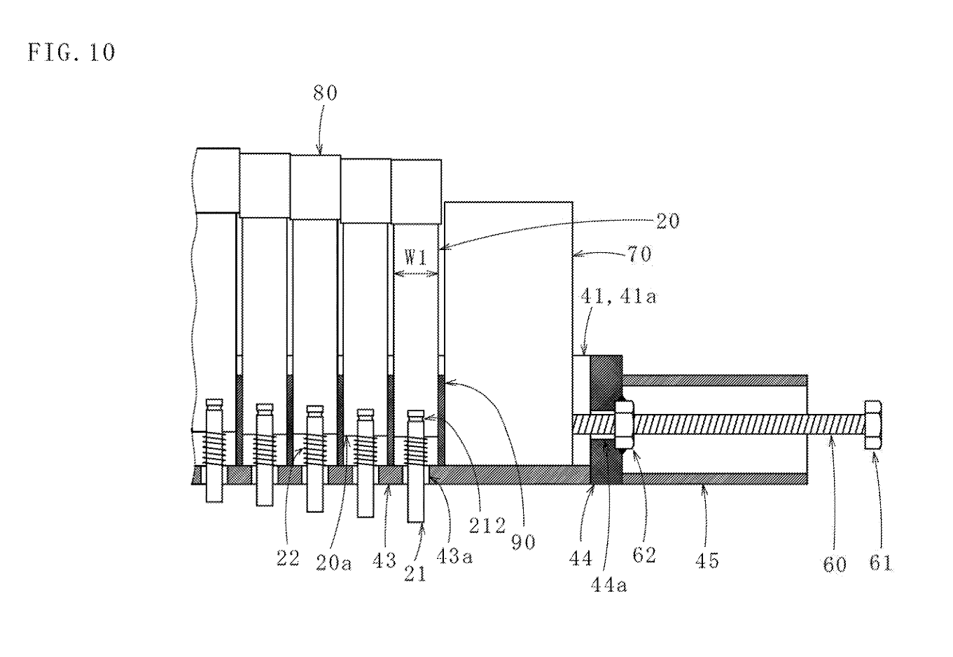

FIG. 8 is a lateral cross-sectional view of the belt cleaner 10 having chips 80 that is provided with the thrust bolts 60 and fall prevention plates 70, and that has spacers 90 inserted between each of the bar-like rubber elastic bodies 20 adjacent to one another. FIG. 9 is a lateral cross-sectional view of the belt cleaner 10 having the chips 80. FIG. 10 is a cross-sectional view in which the belt cleaner 10 having the chips 80 is provided with the thrust bolts 60 and the fall prevention plates 70 and has the spacers 90 inserted between each of the bar-like rubber elastic bodies 20 is partially enlarged.

As illustrated in FIGS. 7, 8, and 10, the belt cleaner 10 is configured to support the stand 40 by attaching a corresponding one of the supporting pipes 45 to each of the flanges 44. By attaching the thrust bolts 60 to the flanges 44, the thrust bolts 60 can be housed inside the supporting pipes 45. By housing the thrust bolts 60 in the supporting pipes 45, adhesion of dust or moisture to the thrust bolts 60 can be prevented, and thus defective rotation and corrosion of the thrust bolts 60 can be controlled. Additionally, since a periphery of a part to which the belt cleaner 10 is attached is narrow, using the supporting pipes 45 as housing tools for the thrust bolts 60 enables the structure of the belt cleaner 10 to be simple.

### REFERENCE SIGNS LIST

10: belt cleaner, 20: bar-like rubber elastic body, 20a: fixed-side terminal (of a bar-like rubber elastic body), 20b: unfixed-side terminal (of a bar-like rubber elastic body), 20c: central axis, 21: fixing axis, 21a: through-hole, 210: pin, 211: bolt, 212: concavo-convex portion, 213: anchor hole, 22: spring, 30: returning-side belt, 40: stand, 40a: groove, 41: pressing-side plate, 41a: upper surface of a pressing-side plate, 42: receiving-side plate, 43: bottom plate, 43a: retention guide hole, 44: flange, 44a: through-hole, 45: supporting pipe, 46: belt cleaner attachment base portion, 50: conveyor stand, 60: thrust bolt, 61: tightening nut, 62: screw (nut), 70: fall prevention plate, 80: chip, 90: spacer, W1: width of a bar-like rubber elastic body in a width direction of a returning-side belt, W2: width of a bar-like rubber elastic body in a traveling direction of a returning-side belt, L: length of a bar-like rubber elastic body

1. A belt cleaner, comprising:
a plurality of bar-like rubber elastic bodies each having a rectangular cross section provided in line in a groove of a stand installed in a width direction of a returning-side belt, wherein
one of fixing axes is attached to a fixed-side end of each of the bar-like rubber elastic bodies in a central axial direction of each of the bar-like rubber elastic bodies, each of the fixing axes is inserted in a corresponding one of retention guide holes provided in a bottom plate of the stand and is vertically retaining a corresponding one of the bar-like rubber elastic bodies, each of springs is inserted in a corresponding one of the fixing axes, and each of the springs is held in between the fixed-side end of a corresponding one of the bar-like rubber elastic bodies and the bottom plate,
one of flanges is provided to each end of the stand, one of through-holes is provided to each of the flanges in the width direction of the returning-side belt, one of screws is provided to each of the through-holes, and one of thrust bolts is rotatably attached to each of the screws, and
after pushing the stand upward until an unfixed-side end of each of the bar-like rubber elastic bodies comes into direct contact with a surface of the returning-side belt, and pressing the bar-like rubber elastic bodies further against the returning-side belt until the springs each exhibit a target compression amount, the thrust bolts are pressed against the bar-like rubber elastic bodies to fix movement of the bar-like rubber elastic bodies in a thrust direction and in a vertical direction.

2. The belt cleaner according to claim 1, wherein
each of the flanges is attached with one of supporting pipes for supporting the stand, and each of the thrust bolts is housed in a corresponding one of the supporting pipes.
